(19) United States
(12) Patent Application Publication
(10) Pub. No.: US 2022/0337532 A1
(43) Pub. Date: Oct. 20, 2022

(54) STORAGE APPARATUS AND ADDRESS SETTING METHOD

(71) Applicant: Hitachi, Ltd., Tokyo (JP)

(72) Inventors: Katsuya TANAKA, Tokyo (JP); Naoya OKADA, Tokyo (JP)

(21) Appl. No.: 17/462,425

(22) Filed: Aug. 31, 2021

(30) Foreign Application Priority Data
Apr. 16, 2021 (JP) 2021-069891

(51) Int. Cl. H04L 12/937; H04L 12/861; H04L 12/931

(52) U.S. Cl. CPC H04L 49/254; H04L 49/9063; H04L 49/70

(57) ABSTRACT

A storage apparatus includes: a plurality of storage controllers including controller interfaces including a plurality of interface ports for connection to the plurality of switches having switch ports, a plurality of virtual networks configured by one of the switch ports is configured in the switch, and the storage controller sends a first packet for specifying the switch port to which the interface port is to be connected from the interface port to the plurality of virtual networks, and determines an address of the interface port used for data transfer between the storage controllers based on a switch number of the switch and a switch port number of the switch port in a case where a second packet including information for specifying the switch number of the switch and the switch port number of the switch port to which the interface port is to be connected is received.

### CLAIM OF PRIORITY

The present application claims priority from Japanese patent application JP 2021-069891 filed on Apr. 16, 2021, the content of which is hereby incorporated by reference into this application.

### BACKGROUND OF THE INVENTION

### 1. Field of the Invention

The present invention relates to a storage apparatus including a plurality of storage controllers connected via switches.

### 2. Description of the Related Art

A storage apparatus having a cluster configuration in which a plurality of storage nodes are gathered operates respective storage nodes in parallel in order to enable parallel access and make data redundant, thereby making it possible to realize high data access performance and high availability. For example, JP 2020-077137 A discloses a large-scale storage apparatus implemented by interconnecting a plurality of storage nodes through a network.

In the following description and drawings, an internal network of a storage apparatus in which a plurality of storage nodes are connected is referred to as a storage internal network. In addition, the storage node may be simply referred to as a node.

The storage node generally includes a storage controller and a randomly accessible nonvolatile storage medium. The storage medium is, for example, a drive box including a large number of solid state drives or hard disk drives. The storage controller includes a frontend interface for connecting a host system, a backend interface for connecting a drive box, and a cache memory for temporarily storing user data read from and written to the drive box by the host system. Further, the storage controller includes a control memory that stores control data handled in the storage controller, and a processor that controls data transfer of the user data and the control data. In the storage apparatus in which a plurality of storage nodes are connected, the plurality of storage nodes mutually send and receive the user data and the control data via the storage internal network.

In addition, Ethernet (registered trademark) has been known as a network standard specification suitable for connection between computer nodes including the storage nodes. In the storage apparatus in which Ethernet is applied to the storage internal network, the plurality of storage nodes are connected by an Ethernet switch.

In the storage apparatus including the plurality of storage nodes, a plurality of storage controllers are integrated and controlled as one storage apparatus, and in order to perform communication between the storage controllers, it is necessary to assign an address to an interface between the storage controllers. As a method of assigning an address, for example, JP 2020-077137 A describes a method in which a storage controller identifier necessary for assigning an address is determined based on a connection destination switch port number of an interface between storage controllers.

In the Ethernet, adjacent devices can exchange information regarding the devices by using a link layer discovery protocol (LLDP) standardized by IEEE802.1AB. An LLDP packet sent from the Ethernet switch to the adjacent device includes identification information of a switch and a connection destination switch port.

### SUMMARY OF THE INVENTION

In order to determine the storage controller identifier in the storage apparatus in which the storage controllers are connected by the Ethernet by using the same method as that in JP 2020-077137 A, it is necessary for the storage controller to set an Internet protocol (IP) address for an interface between the storage controllers based on a connection destination switch and a connection destination switch port such that the storage controller and the switch can communicate with each other.

The switch identification information included in the LLDP packet is, for example, a media access control (MAC) address of a switch management port. Therefore, in order to identify the Ethernet switch that is a connection destination by using the LLDP, the storage controller needs to know in advance the MAC addresses of the switch to be connected and the switch that may be connected.

An object of one aspect of the present invention is to provide a method in which a storage controller identifies a connection destination switch and a connection destination switch port, and sets an IP address of an interface between the storage controllers, and a storage apparatus using the same.

A representative example of the invention disclosed in the present application is as follows. An aspect of the present invention provides a storage apparatus including: a plurality of storage controllers; and a plurality of switches, in which the plurality of storage controllers are communicably connected to each other via the plurality of switches, the storage controller includes one or more controller interfaces including a plurality of interface ports for connection to the plurality of switches, the switch includes a plurality of switch ports, a plurality of virtual networks configured by one of the switch ports is configured in the switch, and the storage controller sends a first packet for specifying the switch port to which the interface port is to be connected from the interface port to the plurality of virtual networks, specifies a switch number of the switch and a switch port number of the switch port based on information for specifying the switch number of the switch and the switch port number of the switch port to which the interface port is to be connected in a case where a second packet including the information is received from the switch, and determines an address of the interface port used for data transfer between the storage controllers based on the specified switch number of the switch and the specified switch port number of the switch port.

The storage controller can identify the connection destination switch and the connection destination switch port and set the IP address of the interface port. Problems, configurations, and effects other than those described above will become apparent by the following description of embodiments.

### BRIEF DESCRIPTION OF THE DRAWINGS

FIG. 1 is a diagram illustrating an example of a hardware configuration of a storage apparatus of a first embodiment;

FIG. 2 is a diagram illustrating an example of a hardware configuration of a storage node of the first embodiment;

FIG. 3 is a diagram for describing an operation in a case where the storage apparatus of the first embodiment receives a Read request from a host system;

FIG. 4 is a diagram for describing an operation in a case where the storage apparatus of the first embodiment receives a Write request from the host system;

FIG. 5 is a diagram illustrating an example of a hardware configuration of a switch of the first embodiment;

FIG. 6 is a diagram illustrating an example of configuration of a VLAN in the switch of the first embodiment;

FIG. 7 is a diagram illustrating an example of configuration of a VLAN in the switch of the first embodiment;

FIG. 8 is a sequence diagram for describing a flow of IP address setting processing for an edge interface port 205 executed by the storage apparatus of the first embodiment;

FIG. 9 is a diagram illustrating an example of a VLAN interface IP address management table of the first embodiment;

FIG. 10 is a flowchart for describing processing executed by an EIF program of the first embodiment;

FIG. 11 is a diagram illustrating an example of a switch management table of the first embodiment;

FIG. 12 is a flowchart for describing processing executed by a switch program of the first embodiment;

FIG. 13 is a diagram illustrating an example of an edge interface port IP address management table of the first embodiment;

FIG. 14 is a flowchart for describing processing executed by the EIF program of the first embodiment;

FIG. 15 is a flowchart for describing connection checking processing executed by a storage controller of the first embodiment;

FIG. 16 is a diagram illustrating an example of a VLAN interface IP address management table of a second embodiment;

FIG. 17 is a flowchart for describing processing executed by an EIF program of the second embodiment;

FIG. 18 is a diagram illustrating an example of a switch management table of the second embodiment;

FIG. 19 is a flowchart for describing processing executed by a switch program of the second embodiment;

FIG. 20 is a diagram illustrating an example of an edge interface port IP address management table of the second embodiment;

FIG. 21 is a flowchart for describing processing executed by the EIF program of the second embodiment;

FIG. 22 is a flowchart for describing connection checking processing executed by a storage controller of the second embodiment;

FIG. 23 is a diagram illustrating a hardware configuration of an edge interface of a third embodiment;

FIG. 24 is a sequence diagram for describing a flow of IP address setting processing for an edge interface port executed by a storage apparatus of a fourth embodiment;

FIG. 25 is a flowchart for describing processing executed by an EIF program of the fourth embodiment;

FIG. 26 is a flowchart for describing processing executed by a switch program of the fourth embodiment;

FIG. 27 is a flowchart for describing processing executed by the EIF program of the fourth embodiment;

FIG. 28 is a sequence diagram for describing a flow of IP address setting processing for an edge interface port executed by a storage apparatus of a fifth embodiment;

FIG. 29 is a flowchart for describing processing executed by an EIF program of the fifth embodiment;

FIG. 30 is a flowchart for describing processing executed by a switch program of the fifth embodiment; and

FIG. 31 is a flowchart for describing processing executed by the EIF program of the fifth embodiment.

### DESCRIPTION OF THE PREFERRED EMBODIMENTS

Hereinafter, some embodiments of the present invention will be described with reference to the drawings. However, the present invention is not to be construed as being limited to the description of the following embodiments. Those skilled in the art can easily understand that the specific configuration can be changed without departing from the spirit or gist of the present invention.

In the configurations of the invention described below, the same or similar configurations or functions are denoted by the same reference signs, and an overlapping description is omitted.

Notations such as “first”, “second”, and “third” in the present specification and the like are attached to identify components, and do not necessarily limit the number or order.

The position, size, shape, range, and the like of each component illustrated in the drawings and the like do not represent the actual position, size, shape, range, and the like in some cases in order to facilitate understanding of the invention. Therefore, the present invention is not limited to the position, size, shape, range, and the like disclosed in the drawings and the like.

In addition, processing may be described with “program” as a subject. The program is executed by a processor, for example, a central processing unit (CPU), and executes predetermined processing. Note that, since the processing executed by the processor is appropriately executed using a storage resource (for example, a memory) and a communication interface apparatus (for example, a communication port), the subject of the processing may be the processor. The processor may also have dedicated hardware other than the CPU.

### First Embodiment

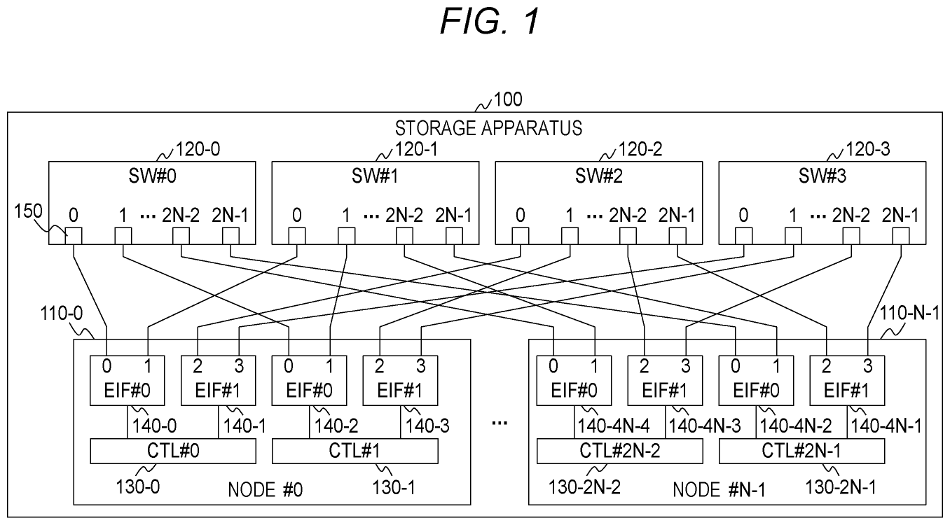

A storage apparatus of a first embodiment will be described with reference to FIGS. 1 to 15.

FIG. 1 is a diagram illustrating an example of a hardware configuration of the storage apparatus of the first embodiment.

The storage apparatus 100 of the first embodiment includes a plurality of storage nodes 110 connected to each other via an internal network. FIG. 1 illustrates the storage apparatus 100 including N storage nodes 110. Here, N is an integer of 2 or more. Note that the present invention is not limited by the number of storage nodes 110 included in the storage apparatus 100. The internal network connecting the storage nodes 110 is referred to as a storage internal network in the present specification.

In the storage apparatus 100 of the first embodiment, a network constructed using a switch 120 and a link of the Ethernet standard is used as the storage internal network. The respective storage nodes 110 are connected to each other via switches 120-0, 120-1, 120-2, and 120-3. Unique identification information (switch number) is set for the switch 120. Note that the number of switches 120 is arbitrary. In addition, the storage internal network may also be constructed using a switch and a link of a protocol different from the Ethernet.

The storage node 110 includes two storage controllers 130. The storage controller 130 includes an edge interface (EIF) 140 for connection to the switch 120. The storage controller 130 illustrated in FIG. 1 includes two edge interfaces 140, is connected to the switches 120-0 and 120-1 by using one edge interface 140, and is connected to the switches 120-2 and 120-3 by using the other edge interface 140.

Note that the number of storage controllers 130 included in the storage node 110 is arbitrary. The storage controllers 130 having different configurations may be mixed in the storage node 110.

Next, a method of identifying identification information (storage controller number) of the storage controller 130 in the storage apparatus 100 of the first embodiment will be described.

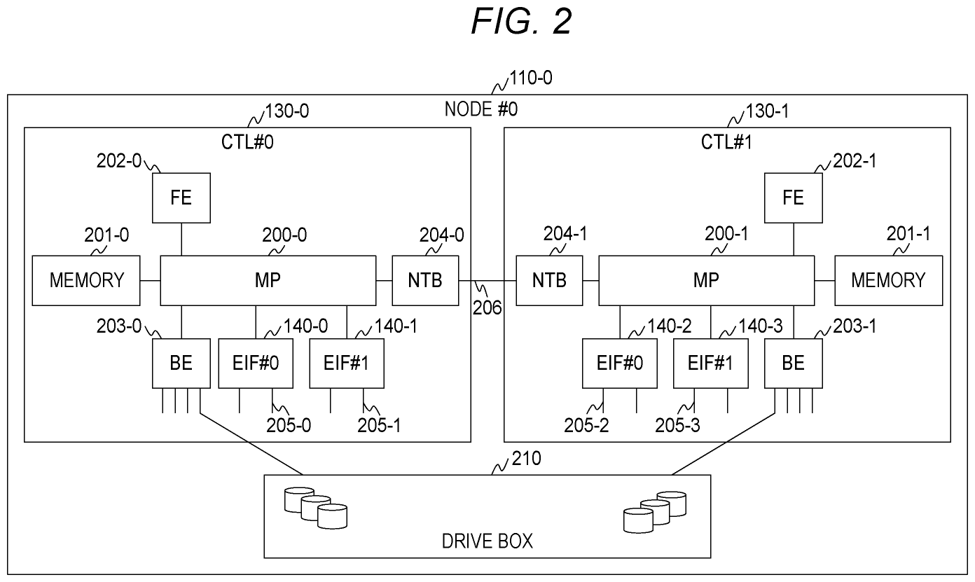

The storage controller 130 includes four edge interface ports 205 (see FIG. 2). For example, an edge interface 140-0 of a storage controller 130-0 includes two edge interface ports 205 having port numbers 0 and 1, and an edge interface 140-1 includes two edge interface ports 205 having port numbers 2 and 3.

Each switch 120 includes 2N switch ports 150. Switch port numbers 0 to 2N−1 are assigned to the respective switch ports 150.

Each edge interface port 205 of the storage controller 130 is connected to the switch port 150 of the switch 120 whose switch number is the same as the port number. At this time, the edge interface port 205 is connected to the switch port 150 whose switch port number is the same as the storage controller number. The storage controller 130 identifies its own storage controller number based on the switch port number of the connection destination switch 120.

FIG. 2 is a diagram illustrating an example of a hardware configuration of the storage node 110 of the first embodiment.

The storage node 110 includes two storage controllers 130 and a drive box 210 that accommodates a plurality of storage media. Here, the storage medium is, for example, a hard disk drive (HDD), a solid state drive (SSD), or the like.

The storage controller 130 includes a processor (MP) 200, a memory 201, a frontend interface (FE) 202, a backend interface (BE) 203, an edge interface 140, and a non-transparent bridge (NTB) 204.

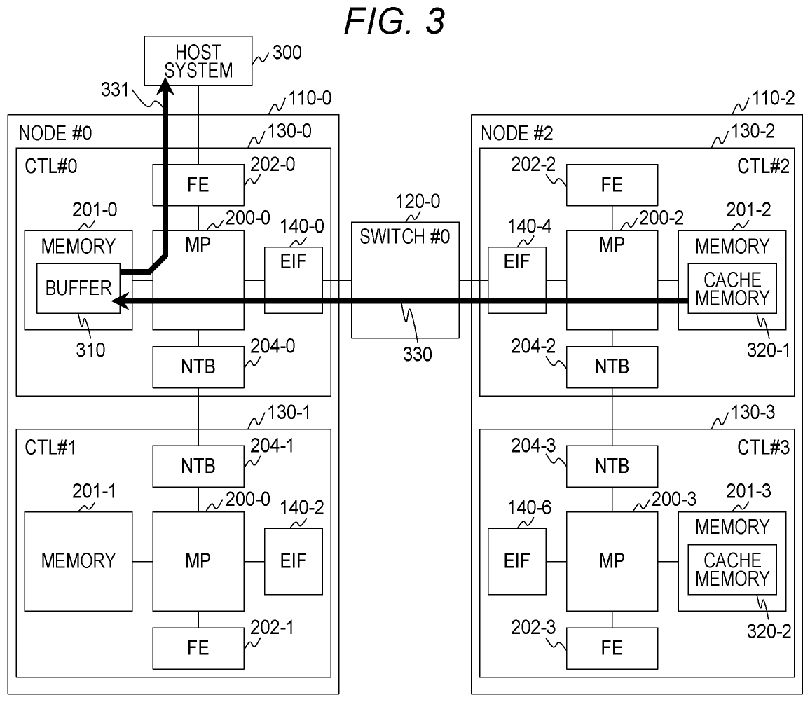

The frontend interface 202 connects a host system 300 (see FIG. 3) that accesses the storage apparatus 100 and the storage apparatus 100. The frontend interface 202 converts a data transfer protocol between the host system 300 and the storage node 110 and a data transfer protocol in the storage controller 130.

The host system 300 and the frontend interface 202 are connected by a transmission line such as a Fibre Channel cable and an Ethernet cable. Furthermore, the host system 300 and the frontend interface 202 may be connected via a storage area network configured by a plurality of transmission lines and a plurality of switches.

The backend interface 203 connects the storage controller 130 and the drive box 210. The backend interface 203 converts a data transfer protocol in the storage controller 130 and a data transfer protocol between the storage controller 130 and the drive box 210.

Note that, in a case where the storage medium in the drive box 210 is an NVMe SSD of PCI Express (PCIe) (registered trademark) connection, the backend interface 203 is a PCIe switch that does not perform protocol conversion.

The processor 200 controls data transfer between the host system 300 connected via the frontend interface 202 and the drive box 210 connected via the backend interface 203. Moreover, the processor 200 controls data transfer between the storage nodes 110.

The memory 201 is a main memory of the processor 200, and stores a program (for example, a storage control program) executed by the processor 200 and information such as a management table referred to by the processor 200. The memory 201 is also used as a cache memory of the storage controller 130.

The NTB 204 is connected to the processor 200 by PCIe. The NTBs 204 of the respective storage controllers 130 can communicate with each other via a non-transparent link 206. The processors 200 of the respective storage controllers 130 can communicate with each other via the non-transparent link 206.

As described above, the storage node 110 has a dual controller configuration with two storage controllers 130.

The edge interface 140 includes one or more edge interface ports 205 for connecting a link of the Ethernet. In the example illustrated in FIG. 2, the edge interface 140-0 includes at least an edge interface port 205-0, the edge interface 140-1 includes at least an edge interface port 205-1, an edge interface 140-2 includes at least an edge interface port 205-2, and an edge interface 140-3 includes at least an edge interface port 205-3. The processor 200 is connected to the switch 120 through the edge interface port 205. As a result, the storage controllers 130 included in the different storage nodes 110 can communicate with each other.

In the storage apparatus 100 of the first embodiment, RDMA over Converged Ethernet (RoCE) is used for data transfer between the storage controllers 130. The RoCE is a protocol that enables data transfer by remote direct memory access (RDMA) on the Ethernet. The edge interface 140 and the like connecting the storage controllers 130 enables RDMA data transfer by the RoCE. In the RoCE, a queue pair (QP) which is a logical communication port (logical port) is used when a program operated on the processor 200 in each storage controller 130 performs communication.

FIG. 3 is a diagram for describing an operation in a case where the storage apparatus 100 of the first embodiment receives a Read request from the host system.

Here, it is assumed that the host system 300 is connected to a frontend interface 202-0 of the storage controller 130-0 of a storage node 110-0. In addition, it is assumed that the frontend interface 202-0 of the storage node 110-0 receives the Read request from the host system 300. Further, it is assumed that data requested by the host system 300 is stored in a cache memory (CM) 320-1 of a storage controller 130-2 of a storage node 110-2.

A processor 200-0 of the storage controller 130-0 sends the read request for the data stored in the cache memory 320-1 from the edge interface 140-0 to an edge interface 140-4. Specifically, the processor 200 executes a data transfer control program to post a data read request (for example, an RDMA Read request) to a QP for communication with the storage controller 130-2 among a plurality of QPs prepared in the storage controller 130-0. Here, “posting” means an operation of storing a request in a send queue of a QP in a memory 201-0. As a result, the RDMA Read request is sent from the edge interface 140-0 to the edge interface 140-4.

Once the read request is received, the edge interface 140-4 transfers the data stored in the cache memory 320-1 to a buffer region 310 of the memory 201-0 through a path 330 passing through a processor 200-2, the edge interface 140-4, the switch 120-0, the edge interface 140-0, and the processor 200-0. In the transfer, the read data passes through the inside of the processors 200-2 and 200-0, but CPU cores of the processors 200-0 and 200-2 are not involved in the data transfer. The same applies to other transfer examples by RDMA. The frontend interface 202-0 transfers the data stored in the buffer region 310 to the host system 300 (path 331).

Note that the data stored in the cache memory 320-1 may be controlled to be sent from the storage controller 130-2 to the storage controller 130-0 by using an RDMA Write request. In this case, first, the processor 200-0 posts a request (for example, the RDMA Write request) for transferring a message requesting the processor 200-2 to send the data to the QP for communication with the storage controller 130-2. The processor 200-2 that has received the message posts the RDMA Write request for transferring the read data to the QP for communication with the storage controller 130-0.

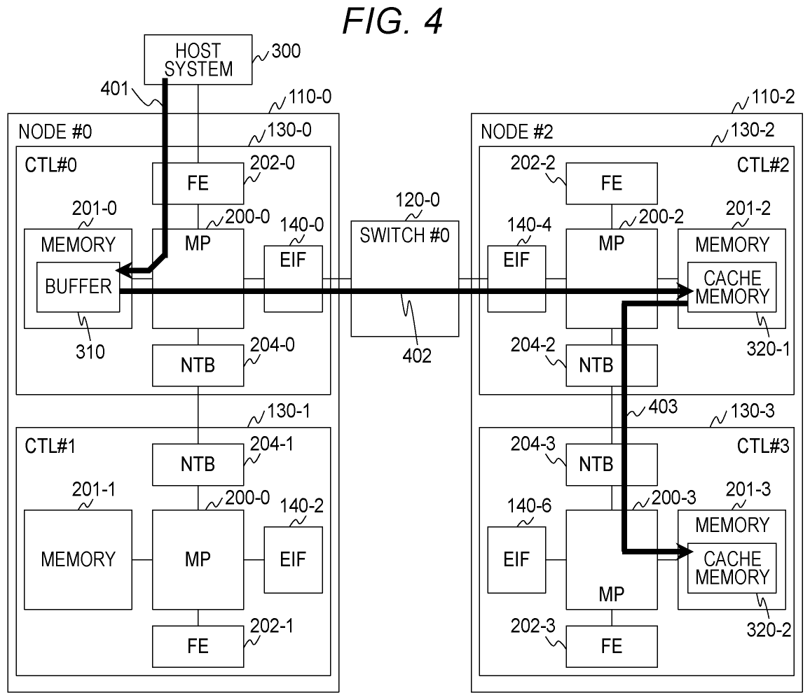

FIG. 4 is a diagram for describing an operation in a case where the storage apparatus 100 of the first embodiment receives the Write request from the host system.

The storage controller 130-0 stores write data received from the host system 300 in the buffer region 310 of the memory 201-0 (path 401). Here, it is assumed that a storage control program (not illustrated) specifies the cache memory 320-1 of the storage controller 130-2 as a write destination of the data received from the host system 300.

The processor 200-0 transfers the data stored in the buffer region 310 to the cache memory 320-1 of the storage controller 130-2 via the switch 120-0 and the processor 200-2 by using an RDMA data transfer function of the edge interfaces 140-0 and 140-4 (path 402). Here, the CPU core of the processor 200-2 is not involved in data transfer.

In order to make the data redundant, the processor 200-2 transfers the data written in the cache memory 320-1 to a cache memory 320-2 of a storage controller 130-3 via NTBs 204-2 and 204-3 and a processor 200-3 (path 403).

After completion of writing of data to the two cache memories 320-1 and 320-2 of the storage node 110-2, the frontend interface 202-0 notifies the host system 300 of completion of writing.

Note that the processor 200-0 may post the data write request (for example, the RDMA Write request) to the QP for communication with the storage controller 130-2 among the plurality of QPs prepared in the storage controller 130-0. As a result, RDMA data transfer can be performed between the edge interface 140-0 and the edge interface 140-4.

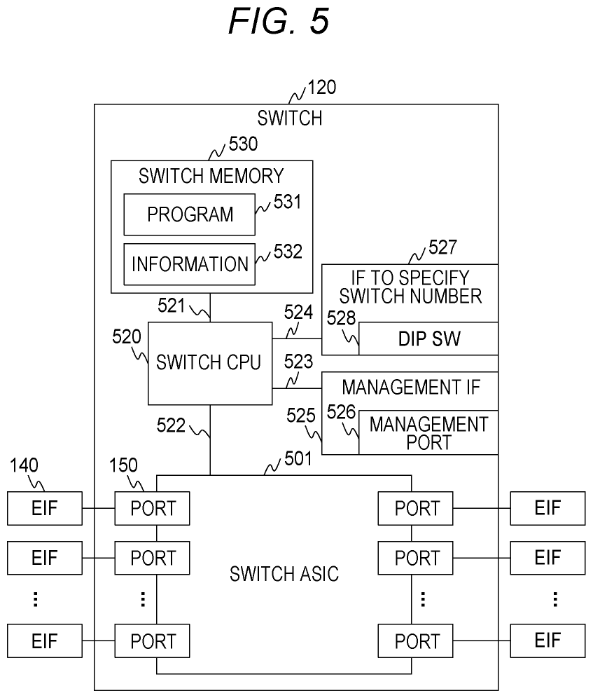

FIG. 5 is a diagram illustrating an example of a hardware configuration of the switch of the first embodiment.

The switch 120 includes the switch port 150, a switch application specific integrated circuit (ASIC) 501, a switch CPU 520, a switch memory 530, a management interface 525, and an interface 527 to specify a switch number. The switch ASIC 501 and the switch CPU 520 are examples of a switch integrated circuit and a switch processor, respectively.

Each switch port 150 is in one-to-one connection with the edge interface port 205 of the edge interface 140 of the storage controller 130. The switch ASIC 501 implements data transfer between the plurality of switch ports 150. The switch CPU 520 configures and controls the switch ASIC 501. The switch memory 530 stores a program 531 executed by the switch CPU 520 and information 532 referred to by the program 531. The program 531 includes a control program of the switch ASIC 501, and the information 532 includes a configuration parameter of the switch 120.

The management interface 525 is provided, for example, as an Ethernet interface card. Further, the management interface 525 includes a management port 526 that is an Ethernet port. The interface 527 to specify a switch number includes a dual in-line package (DIP) switch 528. An administrator of the storage apparatus 100 can set the switch number of the switch 120 by operating the DIP switch 528.

The switch CPU 520 reads the switch number set in the DIP switch 528 via the interface 527 to specify a switch number, and stores the value in the switch memory 530.

The switch CPU 520 and the switch ASIC 501 are connected by a processor bus 522. The switch CPU 520 and the management interface 525 are connected by a processor bus 523. The switch CPU 520 and the switch memory 530 are connected by a memory bus 521. The switch CPU 520 and the interface 527 to specify a switch number are connected by a processor bus 524.

FIG. 6 is a diagram illustrating an example of configuration of a VLAN in the switch 120 of the first embodiment.

The switch 120 is operated as a Layer 2 (L2) Ethernet switch. The VLAN is configured in the switch 120 of the present embodiment. For ease of description, in FIG. 6, only one edge interface port 205 is illustrated for each edge interface 140 connected to the switch port 150, and the storage controller 130 is omitted.

FIG. 6 illustrates an example of configuration of a VLAN 601 for data transfer between the storage controllers. The VLAN 601 is a VLAN in which all the switch ports 150 from 0 to 2N−1 participate.

The edge interface port 205 of a storage controller 130-i whose controller number is i (i is an integer of 0 to 2N−1) is connected to the switch port 150 of the switch 120, the switch port 150 having a port number i. The VLAN 601 is used for data transfer between the storage controllers 130 of the storage apparatus 100 described with reference to FIGS. 3 and 4.

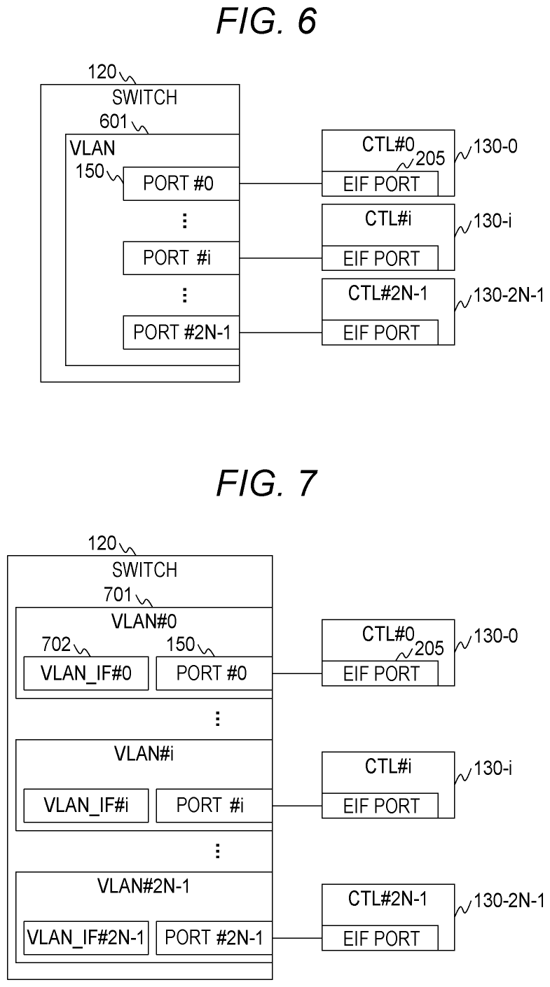

FIG. 7 is a diagram illustrating an example of configuration of a VLAN in the switch 120 of the first embodiment.

A VLAN 701 illustrated in FIG. 7 is a VLAN configured for the storage controller 130 to identify the switch port 150 that is a connection destination of the edge interface 140.

The VLAN 701 is configured for each switch port 150 of the switch 120. In a case where there are 2N switch ports 150 in the switch 120, 2N VLANs 701 will be configured.

There is one switch port 150 belonging to the VLAN 701. In the VLAN 701, a VLAN interface 702 for communicating with the switch CPU 520 is set together with an IP address. The storage controller 130 can access the switch CPU 520 via the VLAN interface 702. That is, the VLAN 701 includes the switch port 150 and the VLAN interface 702. Here, the switch port 150 is connected to the edge interface port 205 of the storage controller 130-i whose controller number is i.

It is assumed that the VLAN 601 and the VLAN 701 are tagged VLANs. A VLAN tag is necessary for setting priority of a priority flow control (PFC) described later. Note that the VLAN 601 and the VLAN 701 can be simultaneously configured in the switch 120.

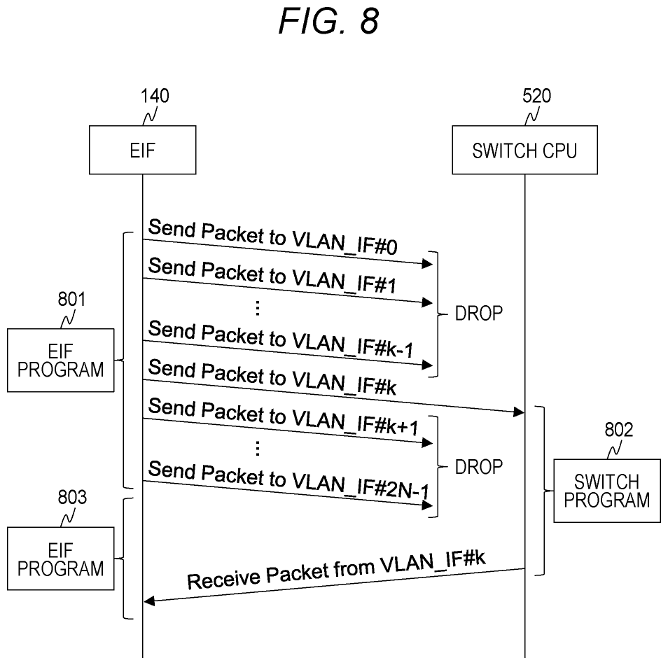

FIG. 8 is a sequence diagram for describing a flow of IP address setting processing for the edge interface port 205 executed by the storage apparatus 100 of the first embodiment.

FIG. 8 illustrates packets sent and received between the edge interface 140 of the storage controller 130 and the switch CPU 520 in order to set an IP address of the edge interface port 205 by using the VLAN 701. The sent and received packets are, for example, user datagram protocol (UDP) packets.

EIF programs 801 and 803 executed by the processor 200 of the storage controller 130 and a switch program 802 executed by the switch CPU 520 cooperate to execute processing described below. In FIG. 8, an outline of a method of setting the IP address of the edge interface port 205 will be described. Details of each program will be described later.

The EIF program 801 executed by the processor 200 sends packets to the VLAN interfaces 702 (VLAN_IF*0 to VLAN_IF*2N−1) of all the VLANs 701 of the switch 120.

Here, it is assumed that the edge interface port 205 is connected to the k-th switch port 150 of the switch 120. In this case, packets other than that for the VLAN interface 702 (VLAN_IF#k) are dropped. The switch CPU 520 receives the packet addressed to the VLAN interface 702 whose VLAN ID is “k” via the k-th switch port 150.

The switch program 802 executed by the switch CPU 520 receives the packet that is addressed to the VLAN interface 702 whose VLAN ID is “k” and is sent from the edge interface 140 via the k-th switch port 150.

The switch program 802 executed by the switch CPU 520 sends, to the edge interface 140, a packet in which the switch number of the switch 120 and the switch port number of the switch port 150 connected to the edge interface port 205 are stored in a payload.

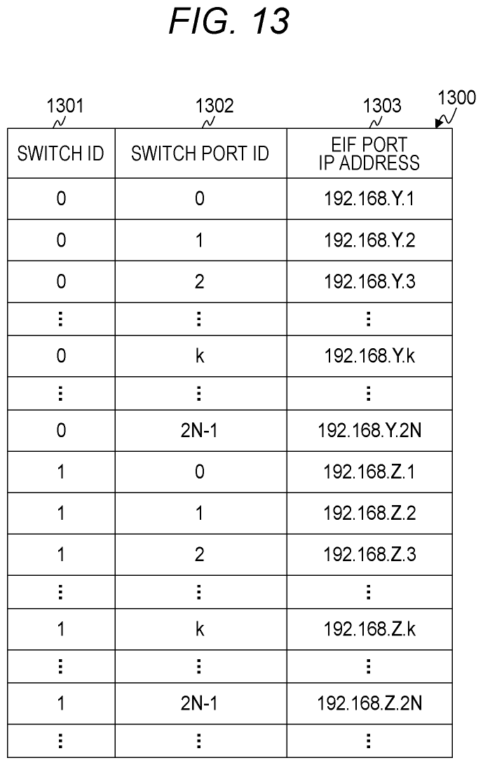

The EIF program 803 executed by the processor 200 receives the packet sent by the switch CPU 520 via the VLAN interface 702 whose VLAN ID is “k”. The EIF program 803 executed by the processor 200 refers to an edge interface port IP address management table 1300 (see FIG. 13) based on the switch number and the switch port number included in the received packet, and sets the IP address to be used in the VLAN 601 for the edge interface port 205.

That is, the storage controller 130 identifies the switch number and the switch port number of the switch 120 to which the edge interface 140 is connected by scanning the VLAN 701 configured in each switch port 150 of the switch 120.

Note that the processor 200 of the storage controller 130 does not execute the EIF program 803 after the EIF program 801 ends. Since it is not known when a reply from the switch CPU 520 comes, the processor 200 of the storage controller 130 executes the EIF program 801 and the EIF program 803 in parallel.

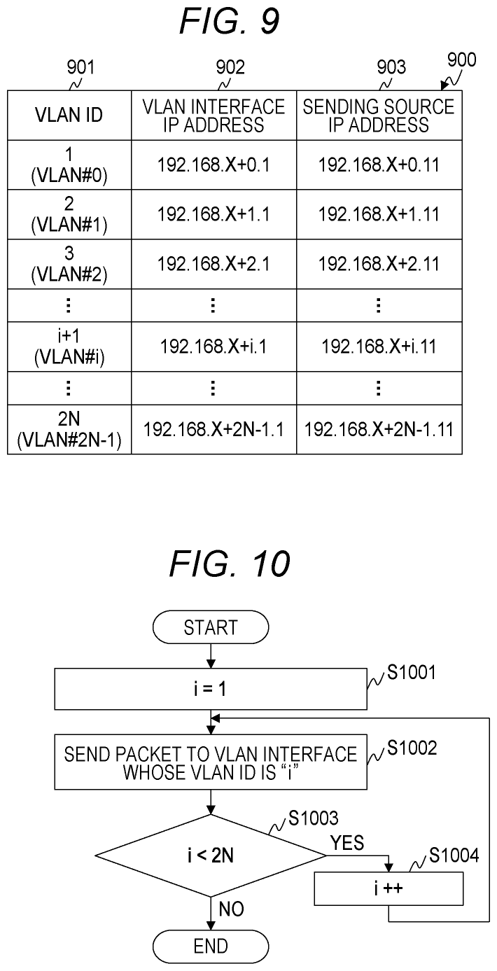

Next, details of each program will be described. First, the operation of the EIF program 801 will be described with reference to FIGS. 9 and 10.

FIG. 9 is a diagram illustrating an example of a VLAN interface IP address management table 900 of the first embodiment.

The VLAN interface IP address management table 900 is stored in the memory 201 of the storage controller 130 and is referred to by the EIF program 801 executed by the processor 200.

The VLAN interface IP address management table 900 stores an entry including a VLAN ID 901, a VLAN interface IP address 902, and a sending source IP address 903. One entry exists for one VLAN 701.

The VLAN ID 901 is a field storing the VLAN ID of the VLAN 701. The VLAN ID is a value set in the VLAN tag included in a header of the packet sent from the edge interface 140 to the VLAN interface 702. Although identification information of the VLAN 701 is added to the VLAN ID 901 for convenience of explanation, it is not included in the actual field.

The VLAN interface IP address 902 is a field storing the IP address of the VLAN interface 702.

The sending source IP address 903 is a field storing a sending source IP address set in the header of the packet sent from the edge interface 140 to the VLAN interface 702.

Note that a character “X” in the VLAN interface IP address 902 and the sending source IP address 903 is an integer of 0 or more.

In the storage apparatus 100 of the first embodiment, the configuration of the VLAN 701 of each switch 120 and the setting of the IP address of the VLAN interface 702 are the same.

FIG. 10 is a flowchart for describing processing executed by the EIF program 801 of the first embodiment.

The EIF program 801 executed by the processor 200 initializes a variable i to 1 (Step S1001).

Next, the EIF program 801 executed by the processor 200 sends a packet addressed to the VLAN interface 702 of the VLAN 701 whose VLAN ID is “i” (Step S1002).

Specifically, the EIF program 801 executed by the processor 200 retrieves an entry in which the VLAN ID 901 of the VLAN interface IP address management table 900 is “i”. The EIF program 801 executed by the processor 200 sends a packet in which the value of the sending source IP address 903 of the retrieved entry is set as a sending source IP address and the value of the VLAN interface IP address 902 of the retrieved entry is set as a sending destination IP address.

Note that, as the sending destination MAC address of the packet, the MAC address of the VLAN interface 702 acquired using an address resolution protocol (ARP) or a broadcast address (FF-FF-FF-FF-FF-FF) is set.

Next, the EIF program 801 executed by the processor 200 determines whether or not the value of the variable i is smaller than the number of VLANs 701 (the number of switch ports 150) configured in the switch 120 (Step S1003). In a case where the number of switch ports 150 is 2N, it is determined whether or not the value of the variable i is smaller than 2N.

In a case where the value of the variable i is smaller than the number of VLANs 701 configured in the switch 120, the EIF program 801 executed by the processor 200 increments the value of the variable i by 1 (Step S1004), and then returns to Step S1002.

In a case where the value of the variable i is equal to the number of VLANs 701 configured in the switch 120, the EIF program 801 executed by the processor 200 ends the processing.

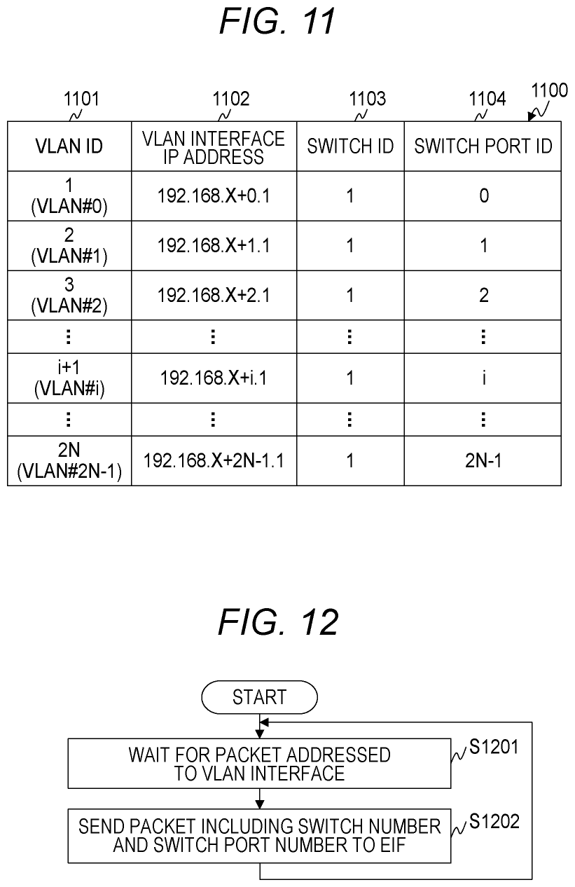

Next, the operation of the switch program 802 will be described with reference to FIGS. 11 and 12.

FIG. 11 is a diagram illustrating an example of a switch management table 1100 of the first embodiment.

The switch management table 1100 is stored in the switch memory 530 and is referred to by the switch program 802 executed by the switch CPU 520. The administrator of the storage apparatus 100 can set and change the switch management table 1100 by accessing the switch CPU 520 via the management port 526.

The switch management table 1100 stores an entry including a VLAN ID 1101, a VLAN interface IP address 1102, a switch ID 1103, and a switch port ID 1104. One entry exists for one VLAN 701.

The VLAN ID 1101 is a field storing the VLAN ID of the VLAN 701. Although identification information of the VLAN 701 is added to the VLAN ID 1101 for convenience of explanation, it is not included in the actual field.

The VLAN interface IP address 1102 is a field storing the IP address of the VLAN interface 702. X is an integer of 0 or more.

The switch ID 1103 is a field storing the switch number which is the identification information of the switch 120. The switch port ID 1104 is a field storing the switch port number which is the identification information of the switch port 150.

FIG. 12 is a flowchart for describing processing executed by the switch program 802 of the first embodiment.

The switch program 802 executed by the switch CPU 520 waits for a packet addressed to the VLAN interface 702 sent by the storage controller 130 in all the VLAN interfaces 702 (Step S1201).

Once the packet is received, the switch program 802 executed by the switch CPU 520 sends a packet in which the switch number and the switch port number are stored in the payload from the VLAN interface 702 that has received the packet to the edge interface 140 of the storage controller 130 (Step S1202). Thereafter, the processing returns to Step S1201.

Specifically, the switch program 802 executed by the switch CPU 520 refers to the switch management table 1100 and retrieves an entry corresponding to the IP address of the VLAN interface 702 included in the packet. The switch program 802 executed by the switch CPU 520 sends a packet in which the values of the switch ID 1103 and the switch port ID 1104 of the retrieved entry are stored in the payload to the sending source IP address of the received packet, that is, the edge interface 140.

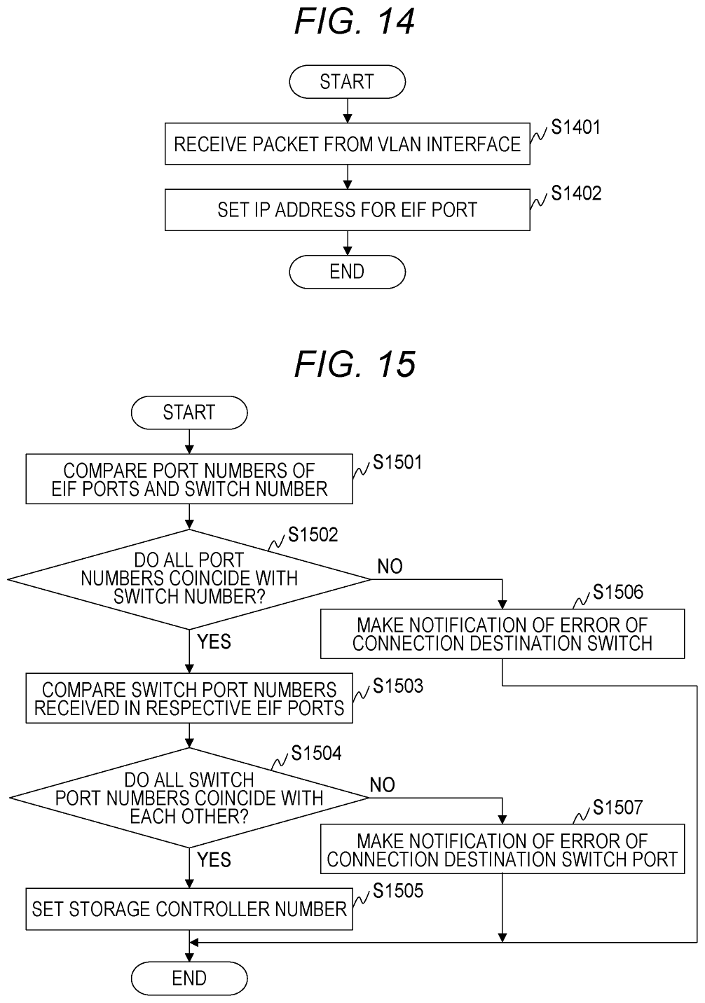

Next, the operation of the EIF program 803 will be described with reference to FIGS. 13 and 14.

FIG. 13 is a diagram illustrating an example of the edge interface port IP address management table 1300 of the first embodiment.

The edge interface port IP address management table 1300 is stored in the memory 201 of the storage controller 130 and is referred to by the EIF program 803 executed by the processor 200.

The edge interface port IP address management table 1300 stores an entry including a switch ID 1301, a switch port ID 1302, and an EIF port IP address 1303. There are as many entries as the number of combinations of the switches 120 and the switch ports 150.

The switch ID 1301 is a field storing the switch number of the switch 120. The switch port ID 1302 is a field storing the switch port number. The EIF port IP address 1303 is a field storing an IP address used for data transfer between the storage controllers 130 via the VLAN 601. Y and Z are integers of 0 or more.

FIG. 14 is a flowchart for describing processing executed by the EIF program 803 of the first embodiment.

The EIF program 803 executed by the processor 200 receives a packet sent from the switch CPU 520 (Step S1401). Here, it is assumed that a packet addressed to the IP address (sending source IP address 903) of the edge interface 140 is received from the VLAN interface 702 whose VLAN ID is “k”.

The EIF program 803 executed by the processor 200 sets an IP address used for data transfer between the storage controllers 130 via the VLAN 601 for the edge interface port 205 based on the switch number and the switch port number included in the payload of the received packet (Step S1402). Thereafter, the EIF program 803 executed by the processor 200 ends the processing.

Specifically, the EIF program 803 executed by the processor 200 refers to the edge interface port IP address management table 1300, and retrieves an entry in which a combination of the values of the switch ID 1301 and the switch port ID 1302 coincides with a combination of the switch number and the switch port number included in the received packet. The EIF program 803 executed by the processor 200 sets the IP address of the EIF port IP address 1303 of the retrieved entry for the edge interface port 205.

FIG. 15 is a flowchart for describing connection checking processing executed by the storage controller 130 of the first embodiment.

The storage apparatus 100 checks connection between the edge interface port 205 of the storage controller 130 and the switch 120 according to a processing flow described below. In a case where the checking result indicates that the connection is correct, the storage apparatus 100 determines the storage controller number.

First, a connection checking program executed by the storage controller 130 compares the port number of each edge interface port 205 with the switch number received from the switch CPU 520 (Step S1501).

The connection checking program executed by the storage controller 130 determines whether or not the port numbers of all the edge interface ports 205 coincide with the switch numbers based on the comparison result (Step S1502).

In a case of the connection illustrated in FIG. 1, since the edge interface port 205 of each storage controller 130 is connected to the switch 120 whose switch number is the same as the port number, the determination result of Step S1502 is YES. In a case where there is at least one edge interface port 205 whose port number does not coincide with the switch number, the determination result in Step S1502 is NO.

In a case where there is at least one edge interface port 205 whose port number does not coincide with the switch number, the connection checking program executed by the storage controller 130 notifies the administrator of the storage apparatus 100 that there is an error in the connection destination switch 120 of the edge interface 140 (Step S1506), and ends the processing.

In a case where the port numbers of all the edge interface ports 205 coincide with the switch numbers, the connection checking program executed by the storage controller 130 compares the switch port numbers received from the switch CPU 520 in the respective edge interface ports 205 (Step S1503).

The connection checking program executed by the storage controller 130 determines whether or not the switch port numbers received by all the edge interface ports 205 coincide with each other based on the comparison result (Step S1504).

In a case where there is at least one edge interface port 205 whose received switch port number does not coincide with the others, the connection checking program executed by the storage controller 130 notifies the administrator of the storage apparatus 100 that there is an error in the connection destination switch port 150 of the edge interface 140 (Step S1507), and ends the processing.

In a case where the switch port numbers received by all the edge interface ports 205 coincide with each other, the connection checking program executed by the storage controller 130 sets the switch port number as the storage controller number (Step S1505) and ends the processing.

Note that, for example, even in a case where data transfer is performed between the storage controllers 130 at the time of increasing the number of storage controllers 130, the method of setting the IP address of the edge interface port 205 described above needs to be executed without being affected by the data transfer. The data transfer between the storage controllers 130 includes user data transfer and control data transfer. The priority of the data transfer between the edge interface 140 and the switch CPU 520 needs to be set higher than the priority of the user data transfer between the storage controllers 130 in which a data transfer amount is particularly large. The higher the priority is, the more preferentially the data transfer is performed. Further, by allocating different traffic classes (resources of data transfer) to the user data transfer between the storage controllers 130 and the data transfer between the edge interface 140 and the switch CPU 520, the data transfer between the edge interface 140 and the switch CPU 520 can be preferentially performed even in a case where congestion occurs due to the user data transfer between the storage controllers 130 on the Ethernet link.

In a case where the number of traffic classes that can be allocated to the Ethernet link is small, for example, one traffic class is shared by the control data transfer between the storage controllers 130 and the data transfer between the edge interface 140 and the switch CPU 520, and the priority of the data transfer between the edge interface 140 and the switch CPU 520 is set higher than that of at least the user data transfer between the storage controllers 130. In addition, different traffic classes are allocated to at least the user data transfer between the storage controllers 130 and the data transfer between the edge interface 140 and the switch CPU 520. As a result, it is possible to suppress a delay in data transfer between the edge interface 140 and the switch CPU 520.

As described above, the storage apparatus 100 of the first embodiment can set the IP address of the edge interface port 205 based on the switch port number of the switch 120.

### Second Embodiment

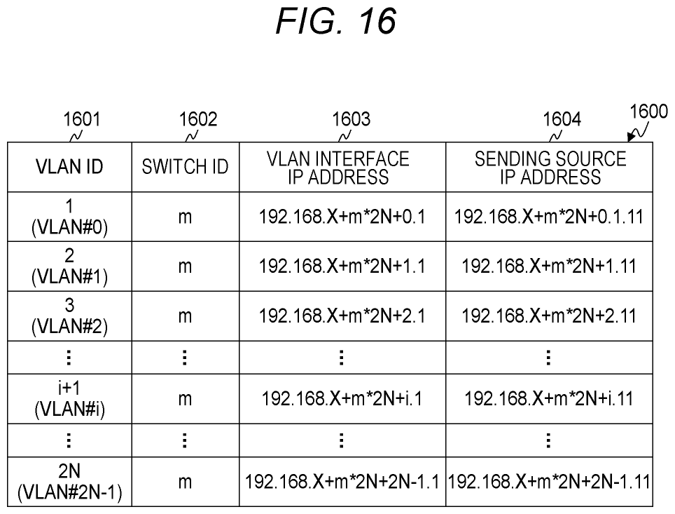

A storage apparatus of a second embodiment will be described with reference to FIGS. 16 to 22.

Since a configuration of the storage apparatus 100 of the second embodiment is the same as the configuration of the storage apparatus 100 of the first embodiment, a description thereof will be omitted. A hardware configuration of a storage node 110 and a switch 120 of the second embodiment is the same as the hardware configuration of the storage node 110 and the switch 120 of the first embodiment. A flow of IP address setting processing for an edge interface port 205 of the second embodiment is the same as that of the first embodiment. In the second embodiment, a procedure of an IP address setting method for the edge interface port 205 is partially different.

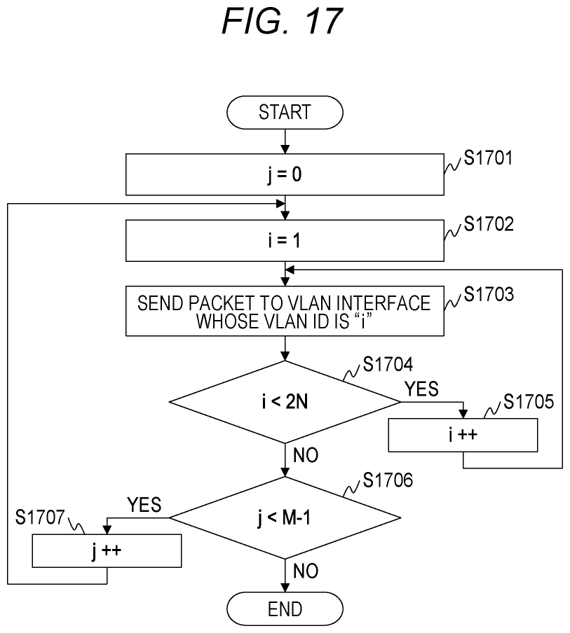

An operation of an EIF program 801 of the second embodiment will be described with reference to FIGS. 16 and 17.

FIG. 16 is a diagram illustrating an example of a VLAN interface IP address management table 1600 of the second embodiment.

The VLAN interface IP address management table 1600 is stored in a memory 201 of a storage controller 130 and is referred to by the EIF program 801 executed by a processor 200.

The VLAN interface IP address management table 1600 stores an entry including a VLAN ID 1601, a switch ID 1602, a VLAN interface IP address 1603, and a sending source IP address 1604. One entry exists for one VLAN 701.

The VLAN ID 1601, the VLAN interface IP address 1603, and the sending source IP address 1604 are the same fields as the VLAN ID 901, the VLAN interface IP address 902, and the sending source IP address 903. The switch ID 1602 is a field storing a switch number of the switch 120 in which a VLAN 701 is configured.

As illustrated in FIG. 16, an IP address of a VLAN interface 702 of the second embodiment is set depending on the switch number of the switch 120.

FIG. 17 is a flowchart for describing processing executed by the EIF program 801 of the second embodiment. The EIF program 801 executed by the processor 200 initializes a variable j to 0 (Step S1701).

Next, the EIF program 801 executed by the processor 200 initializes a variable i to 1 (Step S1702).

Next, the EIF program 801 executed by the processor 200 sends a packet addressed to the VLAN interface 702 of the VLAN 701 whose VLAN ID is “i” (Step S1703).

Specifically, the EIF program 801 executed by the processor 200 retrieves an entry in which the VLAN ID 1601 is “i” and the switch ID 1602 is “j” in the VLAN interface IP address management table 1600. The EIF program 801 executed by the processor 200 sends a packet in which the value of the sending source IP address 1604 of the retrieved entry is set as a sending source IP address and the value of the VLAN interface IP address 1603 of the retrieved entry is set as a sending destination IP address.

Next, the EIF program 801 executed by the processor 200 determines whether or not the value of the variable i is smaller than the number of VLANs 701 (the number of switch ports 150) configured in the switch 120 (Step S1704). In a case where the number of switch ports 150 is 2N, it is determined whether or not the value of the variable i is smaller than 2N.

In a case where the value of the variable i is smaller than the number of VLANs 701 configured in the switch 120, the EIF program 801 executed by the processor 200 increments the value of the variable i by 1 (Step S1705), and then returns to Step S1703.

In a case where the value of the variable i is equal to the number of VLANs 701 configured in the switch 120, the EIF program 801 executed by the processor 200 determines whether or not the value of the variable j is smaller than the number of switches 120 (Step S1706). In a case where the number of switches 120 is M, it is determined whether or not the value of the variable j is smaller than M−1.

In a case where the value of the variable j is smaller than the number of switches 120, the EIF program 801 executed by the processor 200 increments the value of the variable j by 1 (Step S1707), and then returns to Step S1702.

In a case where the value of the variable j is equal to the number of switches 120, the EIF program 801 executed by the processor 200 ends the processing.

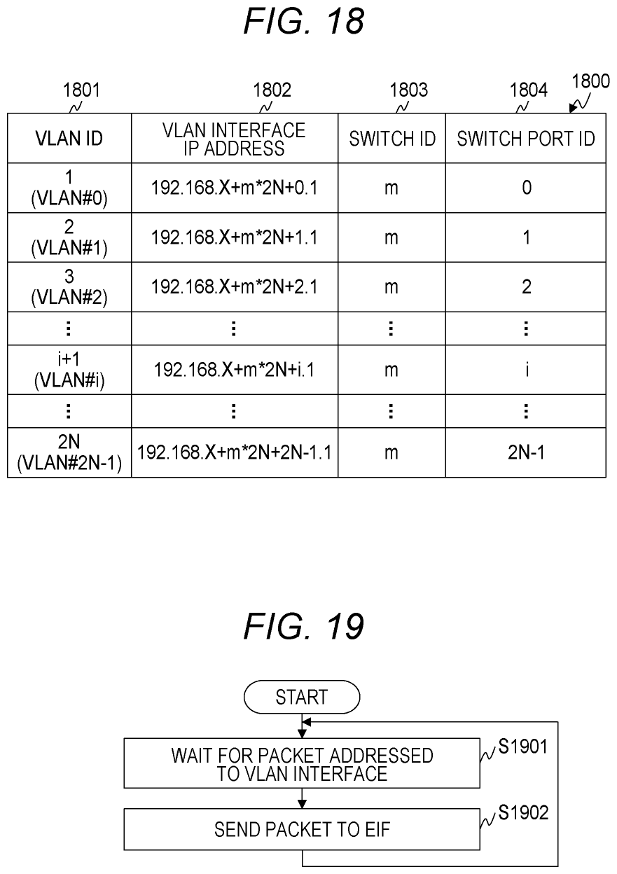

Next, an operation of a switch program 802 of the second embodiment will be described with reference to FIGS. 18 and 19.

FIG. 18 is a diagram illustrating an example of a switch management table 1800 of the second embodiment.

The switch management table 1800 is stored in a switch memory 530 and is referred to by the switch program 802 executed by a switch CPU 520. The administrator of the storage apparatus 100 can set and change the switch management table 1800 by accessing the switch CPU 520 via a management port 526.

The switch management table 1800 stores an entry including a VLAN ID 1801, a VLAN interface IP address 1802, a switch ID 1803, and a switch port ID 1804. One entry exists for one VLAN 701.

The VLAN ID 1801, the VLAN interface IP address 1802, the switch ID 1803, and the switch port ID 1804 are the same fields as the VLAN ID 1101, the VLAN interface IP address 1102, the switch ID 1103, and the switch port ID 1104.

As illustrated in FIG. 18, an IP address of the VLAN interface 702 of the second embodiment is set so as to reflect the switch number of the switch 120 input by the administrator of the storage apparatus 100 using a DIP switch 528.

FIG. 19 is a flowchart for describing processing executed by the switch program 802 of the second embodiment.

The switch program 802 executed by the switch CPU 520 waits for a packet addressed to the VLAN interface 702 sent by the storage controller 130 in all the VLAN interfaces 702 (Step S1901).

Once the packet is received, the switch program 802 executed by the switch CPU 520 sends the packet from the VLAN interface 702 that has received the packet to an edge interface 140 of the storage controller 130 (Step S1902). Thereafter, the processing returns to Step S1901.

Any content can be included in a payload of the packet. For example, the payload may include the switch number and the switch port number by referring to the switch management table 1800. Note that the packet of the second embodiment does not have to include the switch number and the switch port number.

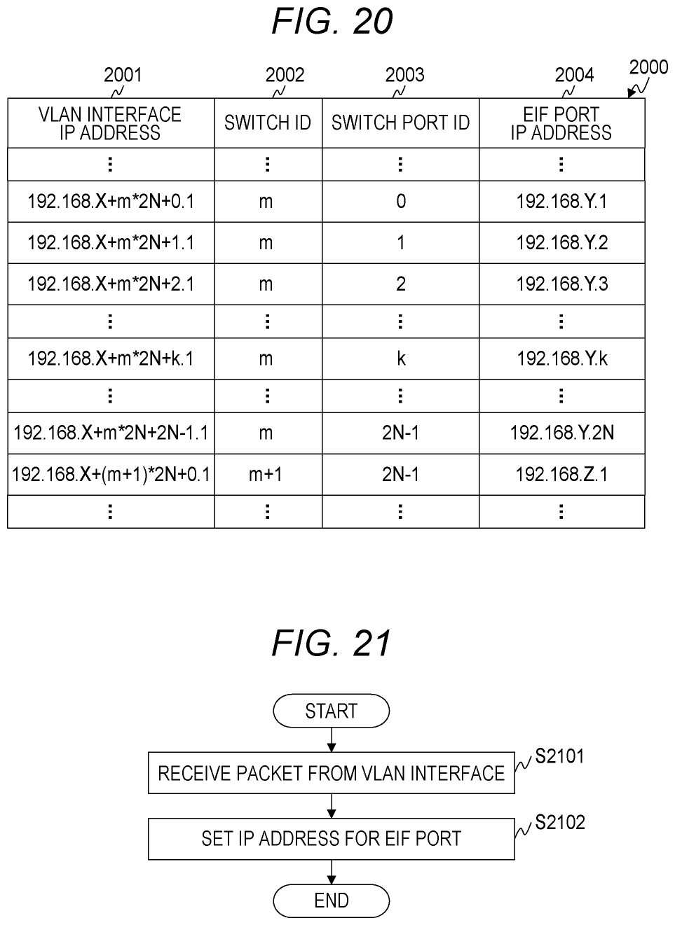

Next, an operation of an EIF program 803 of the second embodiment will be described with reference to FIGS. 20 and 21.

FIG. 20 is a diagram illustrating an example of an edge interface port IP address management table 2000 of the second embodiment.

The edge interface port IP address management table 2000 is stored in the memory 201 of the storage controller 130 and is referred to by the EIF program 803 executed by the processor 200.

The edge interface port IP address management table 2000 stores an entry including a VLAN interface IP address 2001, a switch ID 2002, a switch port ID 2003, and an EIF port IP address 2004. One entry exists for the IP address of one VLAN interface 702.

The switch ID 2002, the switch port ID 2003, and the EIF port IP address 2004 are the same fields as the switch ID 1301, the switch port ID 1302, and the EIF port IP address 1303.

FIG. 21 is a flowchart for describing processing executed by the EIF program 803 of the second embodiment.

The EIF program 803 executed by the processor 200 receives a packet sent from the switch CPU 520 (Step S2101). Here, it is assumed that a packet addressed to the IP address (sending source IP address 1604) of the edge interface 140 is received from the VLAN interface 702 whose VLAN ID is “k”.

The EIF program 803 executed by the processor 200 sets an IP address used for data transfer between the storage controllers 130 via a VLAN 601 for the edge interface port 205 based on the sending source IP address (the IP address of the VLAN interface 702) of the received packet (Step S2102). Thereafter, the EIF program 803 executed by the processor 200 ends the processing.

Specifically, the EIF program 803 executed by the processor 200 refers to the edge interface port IP address management table 2000, and retrieves an entry in which the VLAN interface IP address 2001 coincides with the sending source IP address of the received packet. The EIF program 803 executed by the processor 200 sets the IP address of the EIF port IP address 2004 of the retrieved entry for the edge interface port 205.

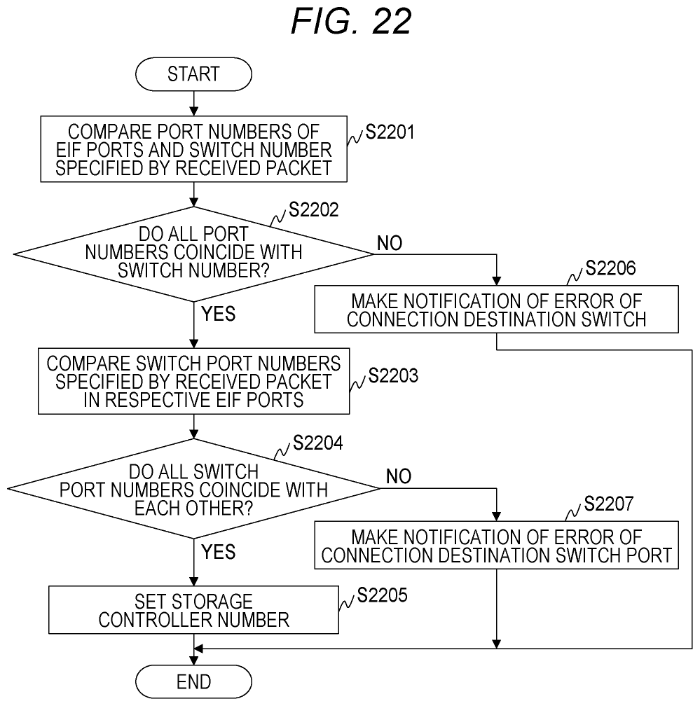

FIG. 22 is a flowchart for describing connection checking processing executed by the storage controller 130 of the second embodiment.

The storage apparatus 100 checks connection between the edge interface port 205 of the storage controller 130 and the switch 120 according to a processing flow described below. In a case where the checking result indicates that the connection is correct, the storage apparatus 100 determines the storage controller number.

First, the connection checking program executed by the storage controller 130 compares the port number of each edge interface port 205 with the switch number specified from the sending source IP address (the IP address of the VLAN interface 702) included in the packet received from the switch CPU 520 (Step S2201).

The connection checking program executed by the storage controller 130 can easily specify the switch number by referring to the edge interface port IP address management table 2000 based on the sending source IP address.

The storage controller 130 determines whether or not the port numbers of all the edge interface ports 205 coincide with the switch numbers based on the comparison result (Step S2202).

In a case of the connection illustrated in FIG. 1, since the edge interface port 205 of each storage controller 130 is connected to the switch 120 whose switch number is the same as the port number, the determination result of Step S2202 is YES. In a case where there is at least one edge interface port 205 whose port number does not coincide with the switch number, the determination result in Step S2202 is NO.

In a case where there is at least one edge interface port 205 whose port number does not coincide with the switch number, the connection checking program executed by the storage controller 130 notifies the administrator of the storage apparatus 100 that there is an error in the connection destination switch 120 of the edge interface 140 (Step S2206), and ends the processing.

In a case where the port numbers of all the edge interface ports 205 coincide with the switch numbers, the connection checking program executed by the storage controller 130 compares the switch port numbers specified from the sending source IP addresses included in the packets received from the switch CPU 520 in the respective edge interface ports 205 (Step S2203).

The connection checking program executed by the storage controller 130 can easily specify the switch port number by referring to the edge interface port IP address management table 2000 based on the sending source IP address.

In a case where there is at least one edge interface port 205 whose switch port number based on the sending source IP address of the received packet does not coincide with the others, the connection checking program executed by the storage controller 130 notifies the administrator of the storage apparatus 100 that there is an error in the connection destination switch port 150 of the edge interface 140 (Step S2207), and ends the processing.

In a case where the switch port numbers based on the source IP addresses of the packets received by all the edge interface ports 205 coincide with each other, the connection checking program executed by the storage controller 130 sets the switch port number as the storage controller number (Step S2205) and ends the processing.

As described above, the storage apparatus 100 of the second embodiment can set the IP address of the edge interface port 205 based on the switch port number of the switch 120, similarly to the storage apparatus 100 of the first embodiment.

### Third Embodiment

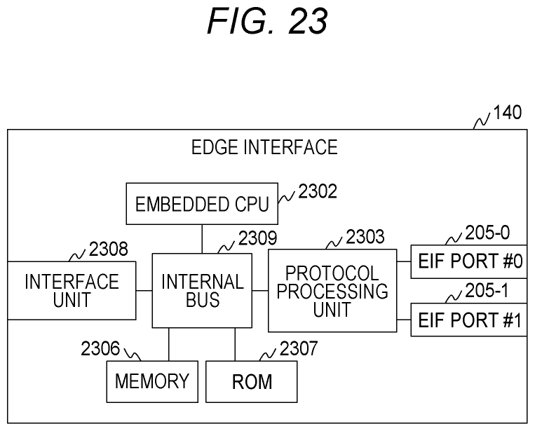

A storage apparatus 100 according to a third embodiment will be described with reference to FIG. 23.

Since a configuration of the storage apparatus 100 of the third embodiment is the same as the configuration of the storage apparatus 100 of the first embodiment, a description thereof will be omitted. A hardware configuration of a storage node 110 and a switch 120 of the third embodiment is the same as the hardware configuration of the storage node 110 and the switch 120 of the first embodiment. A flow of IP address setting processing for an edge interface port 205 of the third embodiment is the same as that of the first embodiment.

In the third embodiment, a hardware configuration of an edge interface 140 is different. FIG. 23 is a diagram illustrating the hardware configuration of the edge interface 140 of the third embodiment.

The edge interface 140 includes an embedded processor 2302, a protocol processing unit 2303, an edge interface port 205, a memory 2306, a read only memory (ROM) 2307, an interface unit 2308, and an internal bus 2309.

The embedded processor 2302 controls the protocol processing unit 2303 and executes EIF programs 801 and 803.

The protocol processing unit 2303 converts a data transfer protocol inside a storage controller 130 and a data transfer protocol between the storage controllers 130.

The edge interface port 205 is connected to a switch port 150 of the switch 120.

The memory 2306 stores a program executed by the embedded processor 2302 and information referred to by the program. The memory 2306 stores a VLAN interface IP address management table 900 and a switch management table 1100.

The ROM 2307 stores firmware of the protocol processing unit 2303 and a program executed by the embedded processor 2302. At the time of startup of the storage apparatus 100, firmware or a program is loaded into the memory 2306 as necessary.

The interface unit 2308 connects the edge interface 140 to a processor bus of the storage controller 130.

The internal bus 2309 connects the embedded processor 2302, the protocol processing unit 2303, the memory 2306, the ROM 2307, and the interface unit 2308 to one another.

The edge interface 140 is provided as, for example, a field programmable gate array (FPGA) card having an RDMA data transfer function.

The edge interface 140 executes IP address setting processing for the edge interface port 205 similar to that of the first embodiment and the second embodiment by the embedded processor 2302 executing the EIF programs 801 and 803 stored in the memory 2306.

As described above, in the storage apparatus 100 of the third embodiment, instead of the storage controller 130, the edge interface 140 executes the IP address setting processing for the edge interface port 205. As a result, the processing load of the storage controller 130 is reduced, such that the performance of the storage apparatus 100 can be improved.

### Fourth Embodiment

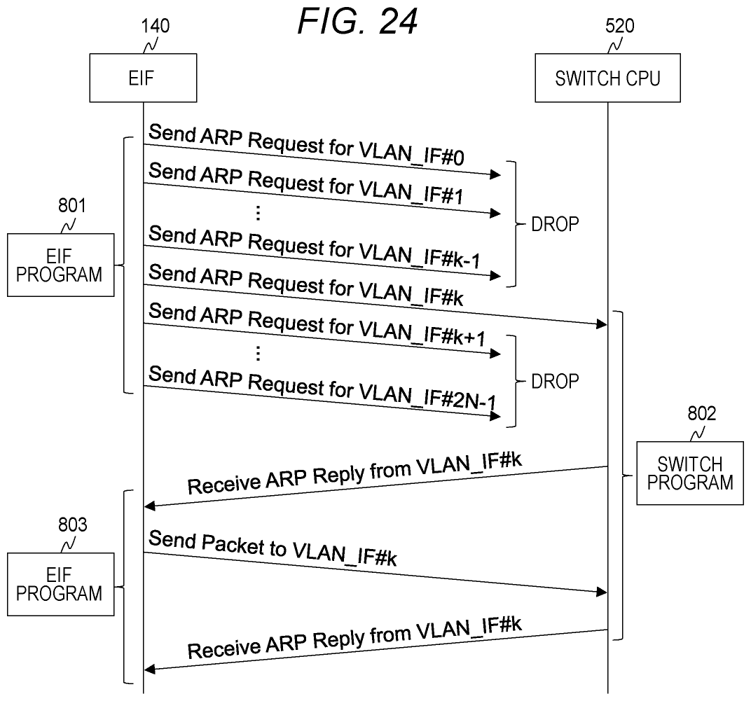

A storage apparatus of a fourth embodiment will be described with reference to FIGS. 24 to 27.

Since a configuration of the storage apparatus 100 of the fourth embodiment is the same as the configuration of the storage apparatus 100 of the first embodiment, a description thereof will be omitted. A hardware configuration of a storage node 110 and a switch 120 of the fourth embodiment is the same as the hardware configuration of the storage node 110 and the switch 120 of the first embodiment.

IP address setting processing for an edge interface port 205 of the fourth embodiment is obtained by partially changing the IP address setting processing for the edge interface port 205 of the first embodiment. The storage apparatus 100 of the fourth embodiment is characterized in that a VLAN 701 of the switch 120 is scanned using an address resolution protocol (ARP) request packet in the IP address setting processing for the edge interface port 205.

FIG. 24 is a sequence diagram for describing a flow of the IP address setting processing for the edge interface port 205 executed by the storage apparatus 100 of the fourth embodiment.

FIG. 24 illustrates packets sent and received between an edge interface 140 of a storage controller 130 and a switch CPU 520 in order to set an IP address of the edge interface port 205 by using the VLAN 701.

EIF programs 801 and 803 executed by the processor 200 of the storage controller 130 and a switch program 802 executed by the switch CPU 520 cooperate to execute processing described below. In FIG. 24, an outline of a method of setting the IP address of the edge interface port 205 will be described. Details of each program will be described later.

The EIF program 801 executed by the processor 200 sends ARP request packets for acquiring media access control (MAC) addresses of VLAN interfaces 702 (VLAN_IF*0 to VLAN_IF*2N−1) of all the VLANs 701 of the switch 120.

Here, it is assumed that the edge interface port 205 is connected to the k-th switch port 150 of the switch 120. In this case, packets other than that for the VLAN interface 702 (VLAN_IF#k) whose MAC address is to be acquiring are dropped. The switch CPU 520 receives the ARP request packet for the VLAN interface 702 (VLAN_IF#k) whose MAC address is to be acquired via the k-th switch port 150.

The switch program 802 executed by the switch CPU 520 receives, via the k-th switch port 150, the ARP request packet for acquiring the MAC address of the VLAN interface 702 whose VLAN ID is “k”, the ARP request packet being sent from the edge interface 140.

The switch program 802 executed by the switch CPU 520 sends an ARP reply packet including the MAC address and the IP address of the VLAN interface 702 whose VLAN ID is “k” to the edge interface 140.

The EIF program 803 executed by the processor 200 receives the ARP reply packet sent by the switch CPU 520 via the VLAN interface 702 whose VLAN ID is “k”. The EIF program 803 executed by the processor 200 sends a UDP packet for acquiring a switch number and a port number to the VLAN interface 702 that is a sending source of the received ARP reply packet.

The switch program 802 executed by the switch CPU 520 receives the UDP packet sent by the storage controller via the VLAN interface 702 whose VLAN ID is “k”. The switch program 802 executed by the switch CPU 520 sends, to the edge interface 140, a packet in which the switch number of the switch 120 and the switch port number of the switch port 150 connected to the edge interface port 205 are stored in a payload.

The EIF program 803 executed by the processor 200 receives the UDP packet sent by the switch CPU 520 via the VLAN interface 702 whose VLAN ID is “k”. The EIF program 803 executed by the processor 200 refers to an edge interface port IP address management table 1300 based on the switch number and the switch port number included in the received UDP packet, and sets the IP address to be used in a VLAN 601 for the edge interface port 205.

Note that the processor 200 of the storage controller 130 does not execute the EIF program 803 after the EIF program 801 ends. Since it is not known when a reply from the switch CPU 520 comes, the processor 200 of the storage controller 130 executes the EIF program 801 and the EIF program 803 in parallel.

Next, details of each program will be described.

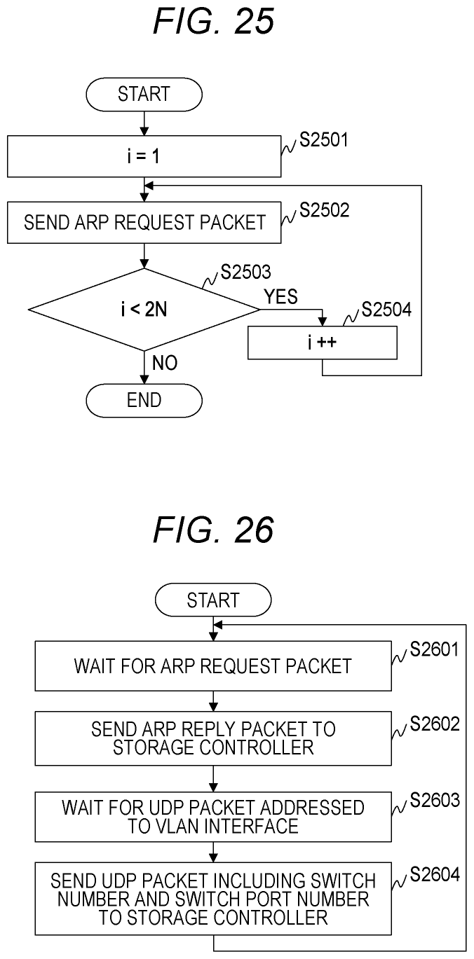

FIG. 25 is a flowchart for describing processing executed by the EIF program 801 of the fourth embodiment.

The EIF program 801 executed by the processor 200 initializes a variable i to 1 (Step S2501).

Next, the EIF program 801 executed by the processor 200 sends an ARP request packet inquiring the MAC address of the VLAN 701 whose VLAN ID is “i” to a broadcast address (FF-FF-FF-FF-FF-FF) (Step S2502).

Next, the EIF program 801 executed by the processor 200 determines whether or not the value of the variable i is smaller than the number of VLANs 701 (the number of switch ports 150) configured in the switch 120 (Step S2503). In a case where the number of switch ports 150 is 2N, it is determined whether or not the value of the variable i is smaller than 2N.

In a case where the value of the variable i is smaller than the number of VLANs 701 configured in the switch 120, the EIF program 801 executed by the processor 200 increments the value of the variable i by 1 (Step S2504), and then returns to Step S2502.

In a case where the value of the variable i is equal to the number of VLANs 701 configured in the switch 120, the EIF program 801 executed by the processor 200 ends the processing.

FIG. 26 is a flowchart for describing processing executed by the switch program 802 of the fourth embodiment.

The switch program 802 executed by the switch CPU 520 waits for reception of an ARP request packet sent by the storage controller 130 in all the VLAN interfaces 702 (Step S2601).

Once the ARP request packet is received, the switch program 802 executed by the switch CPU 520 sends an ARP reply packet from the VLAN interface 702 that has received the ARP request packet to the edge interface port 205 that is a sending source of the ARP request packet (Step S2602). The ARP reply packet includes the MAC address and the IP address of the VLAN interface 702 that has received the ARP request packet.

Next, the switch program 802 executed by the switch CPU 520 waits for an UDP packet addressed to the VLAN interface 702 sent from the storage controller 130 in all the VLAN interfaces 702 (Step S2603).

Once the UDP packet is received, the switch program 802 executed by the switch CPU 520 sends a UDP packet in which the switch number and the switch port number are stored in the payload to the edge interface 140 of the storage controller 130 (Step S2604). The processing of Step S2604 is similar to the processing of Step S1202.

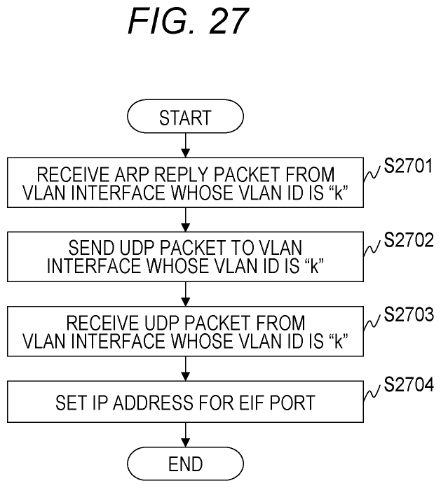

FIG. 27 is a flowchart for describing processing executed by the EIF program 803 of the fourth embodiment.

The EIF program 803 executed by the processor 200 receives the ARP reply packet from the VLAN interface 702 whose VLAN ID is “k” (Step S2701).

Next, the EIF program 803 executed by the processor 200 sends a UDP packet including the IP address of the VLAN interface 702 included in the received ARP reply packet as a sending destination IP address and including the IP address of the storage controller 130 as a sending source IP address (Step S2702). The IP address of the storage controller 130 can be specified by referring to a VLAN interface IP address management table 900 based on the IP address of the VLAN interface 702.

Next, the EIF program 803 executed by the processor 200 receives the UDP packet sent from the switch CPU 520 (Step S2703). Here, a packet addressed to the IP address (sending source IP address 903) of the edge interface 140 is received from the VLAN interface 702 whose VLAN ID is “k”.

The EIF program 803 executed by the processor 200 sets an IP address used for data transfer between the storage controllers 130 via a VLAN 601 for the edge interface port 205 based on the switch number and the switch port number included in the payload of the received packet (Step S2704). Thereafter, the EIF program 803 executed by the processor 200 ends the processing. The processing of Step S2704 is similar to the processing of Step S1402.

As described above, the storage controller 130 of the storage apparatus 100 of the fourth embodiment can identify the switch number and the switch port number of the switch 120 to which the edge interface 140 is connected by scanning the VLAN 701 configured in the switch port 150 of the switch 120 by using the ARP request packet.

Note that, in the storage apparatus 100 of the fourth embodiment, the edge interface 140 may execute the EIF programs 801 and 803 as in the third embodiment.

### Fifth Embodiment

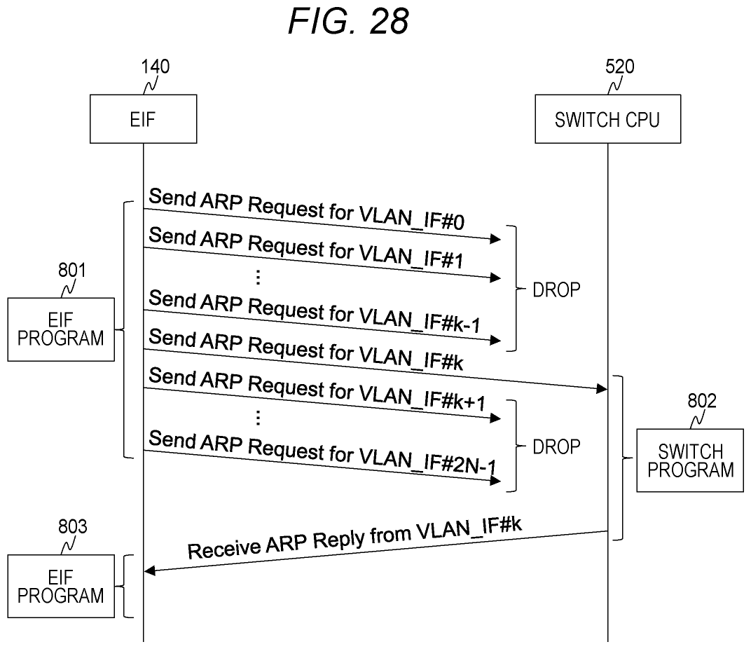

A storage apparatus 100 according to a fifth embodiment will be described with reference to FIGS. 28 to 31.

Since a configuration of the storage apparatus 100 of the fifth embodiment is the same as the configuration of the storage apparatus 100 of the second embodiment, a description thereof will be omitted. A hardware configuration of a storage node 110 and a switch 120 of the fifth embodiment is the same as the hardware configuration of the storage node 110 and the switch 120 of the second embodiment.

IP address setting processing for an edge interface port 205 of the fifth embodiment is obtained by partially changing the IP address setting processing for the edge interface port 205 of the second embodiment. The storage apparatus 100 of the fifth embodiment is characterized in that a VLAN 701 of the switch 120 is scanned using an ARP request packet in the IP address setting processing for the edge interface port 205.

FIG. 28 is a sequence diagram for describing a flow of the IP address setting processing for the edge interface port 205 executed by the storage apparatus 100 of the fifth embodiment.

FIG. 28 illustrates packets sent and received between an edge interface 140 of a storage controller 130 and a switch CPU 520 in order to set an IP address of the edge interface port 205 by using the VLAN 701.

EIF programs 801 and 803 executed by the processor 200 of the storage controller 130 and a switch program 802 executed by the switch CPU 520 cooperate to execute processing described below. In FIG. 28, an outline of a method of setting the IP address of the edge interface port 205 will be described. Details of each program will be described later.

The EIF program 801 executed by the processor 200 sends ARP request packets for acquiring MAC addresses of VLAN interfaces 702 (VLAN_IF*0 to VLAN_IF*2N−1) of all the VLANs 701 of the switch 120.

Here, it is assumed that the edge interface port 205 is connected to the k-th switch port 150 of the switch 120. In this case, packets other than that for the VLAN interface 702 (VLAN_IF#k) whose MAC address is to be acquired are dropped. The switch CPU 520 receives the ARP request packet for the VLAN interface 702 (VLAN_IF#k) whose MAC address is to be acquired via the k-th switch port 150.

The switch program 802 executed by the switch CPU 520 receives, via the k-th switch port 150, the ARP request packet for acquiring the MAC address of the VLAN interface 702 whose VLAN ID is “k”, the ARP request packet being sent from the edge interface 140.

The switch program 802 executed by the switch CPU 520 sends an ARP reply packet including the MAC address and the IP address of the VLAN interface 702 whose VLAN ID is “k” to the edge interface 140.

The EIF program 803 executed by the processor 200 receives the ARP reply packet sent by the switch CPU 520 via the VLAN interface 702 whose VLAN ID is “k”. The EIF program 803 executed by the processor 200 refers to an edge interface port IP address management table 2000 based on the IP address of the VLAN interface 702 included in the received ARP reply packet, and sets the IP address to be used in a VLAN 601 for the edge interface port 205.

Note that the processor 200 of the storage controller 130 does not execute the EIF program 803 after the EIF program 801 ends. Since it is not known when a reply from the switch CPU 520 comes, the processor 200 of the storage controller 130 executes the EIF program 801 and the EIF program 803 in parallel.

Next, details of each program will be described.

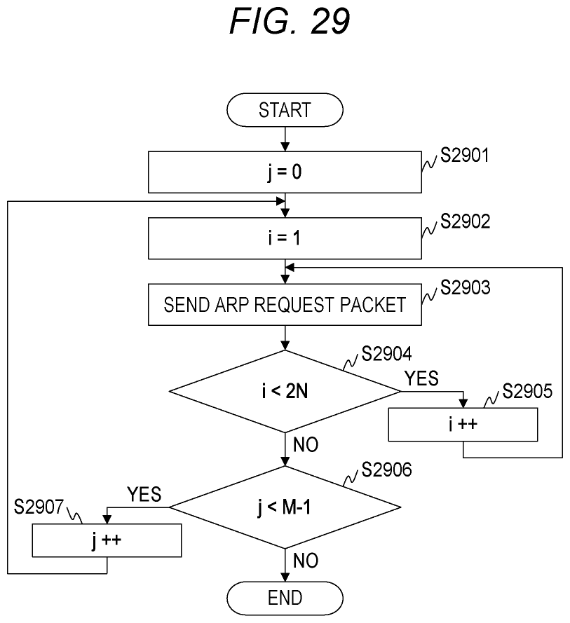

FIG. 29 is a flowchart for describing processing executed by the EIF program 801 of the fifth embodiment.

The EIF program 801 executed by the processor 200 initializes a variable j to 0 (Step S2901).

Next, the EIF program 801 executed by the processor 200 initializes a variable i to 1 (Step S2902).

Next, the EIF program 801 executed by the processor 200 sends, from the edge interface port 205, an ARP request packet inquiring the MAC address of the VLAN 701 whose VLAN ID is “i” to a broadcast address (FF-FF-FF-FF-FF-FF) (Step S2903).

Next, the EIF program 801 executed by the processor 200 determines whether or not the value of the variable i is smaller than the number of VLANs 701 (the number of switch ports 150) configured in the switch 120 (Step S2904). In a case where the number of switch ports 150 is 2N, it is determined whether or not the value of the variable i is smaller than 2N.

In a case where the value of the variable i is smaller than the number of VLANs 701 configured in the switch 120, the EIF program 801 executed by the processor 200 increments the value of the variable i by 1 (Step S2905), and then returns to Step S2903.

In a case where the value of the variable i is equal to the number of VLANs 701 configured in the switch 120, the EIF program 801 executed by the processor 200 determines whether or not the value of the variable j is smaller than the number of switches 120 (Step S2906). In a case where the number of switches 120 is M, it is determined whether or not the value of the variable j is smaller than M−1.

In a case where the value of the variable j is smaller than the number of switches 120, the EIF program 801 executed by the processor 200 increments the value of the variable j by 1 (Step S2907), and then returns to Step S2902.

In a case where the value of the variable j is equal to the number of switches 120, the EIF program 801 executed by the processor 200 ends the processing.

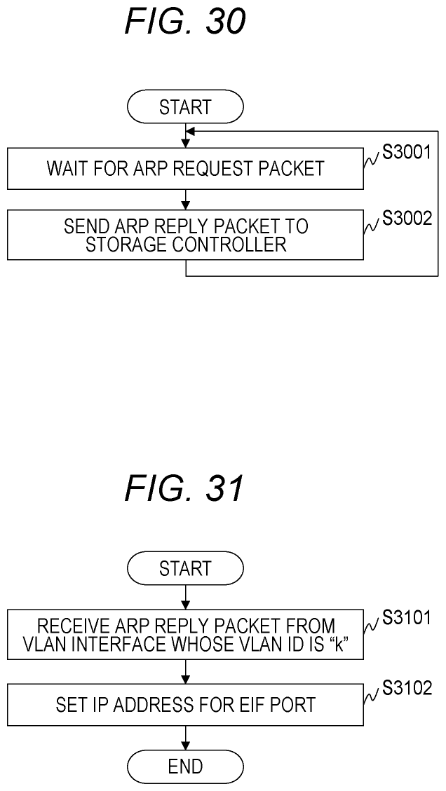

FIG. 30 is a flowchart for describing processing executed by the switch program 802 of the fifth embodiment. The switch program 802 executed by the switch CPU 520 waits for an ARP request packet sent by the storage controller 130 in all the VLAN interfaces 702 (Step S3001).

Once the ARP request packet is received, the switch program 802 executed by the switch CPU 520 sends an ARP reply packet from the VLAN interface 702 that has received the ARP request packet to the edge interface port 205 that is a sending source of the ARP request packet (Step S3002). Thereafter, the processing returns to Step S3001.

FIG. 31 is a flowchart for describing processing executed by the EIF program 803 of the fifth embodiment.

The EIF program 803 executed by the processor 200 receives the ARP reply packet from the VLAN interface 702 whose VLAN ID is “k” (Step S3101).

Next, the EIF program 803 executed by the processor 200 sets an IP address used for data transfer between the storage controllers 130 via the VLAN 601 for the edge interface port 205 based on the sending source IP address (the IP address of the VLAN interface 702) included in the received ARP packet (Step S3102). Thereafter, the EIF program 803 executed by the processor 200 ends the processing. The processing of Step S3102 is similar to the processing of Step S2102.

As described above, the storage controller 130 of the storage apparatus 100 of the fifth embodiment can identify the switch number and the switch port number of the switch 120 to which the edge interface 140 is connected by scanning the VLAN 701 configured in the switch port 150 of the switch 120 by using the ARP request packet.

Note that, in the storage apparatus 100 of the fifth embodiment, the edge interface 140 may execute the EIF programs 801 and 803 as in the third embodiment.

Note that the present invention is not limited to the embodiments described above, but includes various modified examples. For example, the configurations of the embodiments described above have been described in detail in order to explain the present invention in an easy-to-understand manner, and the present invention is not necessarily limited to those having all the configurations described. In addition, a part of the configuration of each embodiment can be added with another configuration, can be deleted, and can be replaced with another configuration.

In addition, some or all of the above-described configurations, functions, processing units, processing means, and the like may be implemented by hardware, for example, by designing with an integrated circuit. In addition, the present invention can also be implemented by a program code of software that implements the functions of the embodiments. In this case, a storage medium in which the program code is recorded is provided to a computer, and a processor included in the computer reads the program code stored in the storage medium. In this case, the program code itself read from the storage medium implements the functions of the above-described embodiments, and the program code itself and the storage medium storing the program code constitute the present invention. As the storage medium for supplying such a program code, for example, a flexible disk, a CD-ROM, a DVD-ROM, a hard disk, a solid state drive (SSD), an optical disk, a magneto-optical disk, a CD-R, a magnetic tape, a nonvolatile memory card, a ROM, or the like is used.

In addition, the program code for implementing the functions described in the present embodiment can be implemented by a wide range of programs or script languages such as assembler, C/C++, perl, Shell, PHP, Python, Java (registered trademark), and the like.

Furthermore, the program code of the software that implements the functions of the embodiments may be distributed via a network to be stored in storage means such as a hard disk or a memory of a computer or a storage medium such as a CD-RW or a CD-R, and a processor included in the computer may read and execute the program code stored in the storage means or the storage medium.

In the above-described embodiments, the control lines and information lines indicate those that are considered necessary for explanation, and do not necessarily indicate all the control lines and information lines in the product. All the configurations may be connected to each other.

What is claimed is:

1. A storage apparatus comprising:
a plurality of storage controllers; and
a plurality of switches, wherein
the plurality of storage controllers are communicably connected to each other via the plurality of switches,
the storage controller includes one or more controller interfaces including a plurality of interface ports for connection to the plurality of switches,
the switch includes a plurality of switch ports,
a plurality of virtual networks configured by one of the switch ports is configured in the switch, and
the storage controller sends a first packet for specifying the switch port to which the interface port is to be connected from the interface port to the plurality of virtual networks, specifies a switch number of the switch and a switch port number of the switch port based on information for specifying the switch number of the switch and the switch port number of the switch port to which the interface port is to be connected in a case where a second packet including the information is received from the switch, and determines an address of the interface port used for data transfer between the storage controllers based on the specified switch number of the switch and the specified switch port number of the switch port.

2. The storage apparatus according to claim 1, wherein the second packet is a packet in which the switch number of the switch and the switch port number of the switch port to which the storage controller is to be connected are stored in a payload.

3. The storage apparatus according to claim 1, wherein the second packet includes, as a sending source address, an address of the virtual network generated based on the switch number of the switch and the switch port number of the switch port configuring the virtual network.

4. The storage apparatus according to claim 1, wherein the storage controller determines whether or not a port number of the interface port coincides with a switch number of a connection destination switch that is the switch connected via the interface port, determines whether or not switch port numbers of connection destination switch ports that are the switch ports to which the interface ports in the plurality of interface ports are connected coincide with each other, and sets the determined address for the interface port in a case where the port number of the interface port coincides with the switch number of the connection destination switch and the switch port numbers of the connection destination switch ports in the plurality of interface ports coincide with each other.

5. The storage apparatus according to claim 1, wherein the switch includes a unit for inputting the switch number of the switch.

6. An address setting method executed by a storage apparatus, wherein
the storage apparatus includes a plurality of storage controllers and a plurality of switches,
the plurality of storage controllers are communicably connected to each other via the plurality of switches,
the storage controller includes one or more controller interfaces including a plurality of interface ports for connection to the plurality of switches,
the switch includes a plurality of switch ports,
a plurality of virtual networks configured by one of the switch ports is configured in the switch, and
the address setting method comprises:
sending, by the storage controller, a first packet for specifying the switch port to which the interface port is to be connected from the interface port to the plurality of virtual networks;
specifying, by the storage controller, a switch number of the switch and a switch port number of the switch port based on information for specifying the switch number of the switch and the switch port number of the switch port to which the interface port is to be connected in a case where a second packet including the information is received from the switch; and
determining, by the storage controller, an address of the interface port used for data transfer between the storage controllers based on the specified switch number of the switch and the specified switch port number of the switch port.

7. The address setting method according to claim 6, wherein the second packet is a packet in which the switch number of the switch and the switch port number of the switch port to which the storage controller is to be connected are stored in a payload.

8. The address setting method according to claim 6, wherein the second packet includes, as a sending source address, an address of the virtual network generated based on the switch number of the switch and the switch port number of the switch port configuring the virtual network.

9. The address setting method according to claim 6, further comprising:
determining, by the storage controller, whether or not a port number of the interface port coincides with a switch number of a connection destination switch that is the switch connected via the interface port;
determining, by the storage controller, whether or not switch port numbers of connection destination switch ports that are the switch ports to which the interface ports in the plurality of interface ports are connected coincide with each other; and
setting, by the storage controller, the determined address for the interface port in a case where the port number of the interface port coincides with the switch number of the connection destination switch and the switch port numbers of the connection destination switch ports in the plurality of interface ports coincide with each other.

10. The address setting method according to claim 6, wherein the switch includes a unit for inputting the switch number of the switch.

11. A storage apparatus comprising:
a plurality of storage controllers; and
a plurality of switches, wherein
the plurality of storage controllers are communicably connected to each other via the plurality of switches,
the storage controller includes one or more controller interfaces including a plurality of interface ports for connection to the plurality of switches,
the switch includes a plurality of switch ports,
a plurality of virtual networks configured by one of the switch ports is configured in the switch, and
the controller interface sends a first packet for specifying the switch port to which the interface port is to be connected from the interface port to the plurality of virtual networks, specifies a switch number of the switch and a switch port number of the switch port based on information for specifying the switch number of the switch and the switch port number of the switch port to which the interface port is to be connected in a case where a second packet including the information is received from the switch, and determines an address of the interface port used for data transfer between the storage controllers based on the specified switch number of the switch and the specified switch port number of the switch port.

12. The storage apparatus according to claim 11, wherein the second packet is a packet in which the switch number of the switch and the switch port number of the switch port to which the storage controller is to be connected are stored in a payload.

13. The storage apparatus according to claim 11, wherein the second packet includes, as a sending source address, an address of the virtual network generated based on the switch number of the switch and the switch port number of the switch port configuring the virtual network.

14. The storage apparatus according to claim 11, wherein the storage controller determines whether or not a port number of the interface port coincides with a switch number of a connection destination switch that is the switch connected via the interface port, determines whether or not switch port numbers of connection destination switch ports that are the switch ports to which the interface ports in the plurality of interface ports are connected coincide with each other, and sets the determined address for the interface port in a case where the port number of the interface port coincides with the switch number of the connection destination switch and the switch port numbers of the connection destination switch ports in the plurality of interface ports coincide with each other.

15. The storage apparatus according to claim 11, wherein the switch includes a unit for inputting the switch number of the switch.
